(19) United States
(12) Patent Application Publication
(10) Pub. No.: US 2026/0307225 A1
(43) Pub. Date: Oct. 8, 2026

(54) PORTABLE ELECTRIC RIVET NUT SETTING TOOL

(71) Applicant: Black & Decker Inc., New Britain, CT (US)

(72) Inventors: Markus ROMPEL, Runkel (DE); Tobias HEEP, Hadamar (DE); Benjamin SCHMIDT, Mainz (DE)

(21) Appl. No.: 19/450,982

(22) Filed: Jan. 16, 2026

(30) Foreign Application Priority Data
Mar. 17, 2025 (GB) 2503859.7

(51) Int. Cl. B25B 27/00; B21J 15/04; B21J 15/10; B21J 15/26

(52) U.S. Cl. CPC B25B 27/0014; B21J 15/043; B21J 15/105; B21J 15/26

(57) ABSTRACT

A portable electric rivet nut setting tool comprising an electric motor having a motor output shaft, a rivet nut setting mechanism having a threaded rod portion for mating with a rivet nut to be set and an anvil against which the rivet nut can be urged in use, the rivet nut setting mechanism being operatively coupled to the motor output shaft via a transmission of the tool which in use causes linear relative movement between the threaded rod portion and the anvil for setting a rivet nut in use, the transmission comprising a conversion mechanism for converting torque into a linear force for causing said linear relative movement between the threaded rod portion and the anvil of the rivet nut setting mechanism.

### CROSS-REFERENCE TO RELATED APPLICATION

The subject application claims priority to and the benefit of GB Application Serial No. 2503859.7 filed on Mar. 17, 2025, the entire contents of which are hereby incorporated by reference.

### FIELD

This specification relates to a portable electric rivet nut setting tool.

### BACKGROUND

During construction a rivet nut can be used to provide a threaded attachment portion in an object wherein a tool specially configured for setting rivet nuts is used for this purpose. Pneumatic rivet nut setting tools are known but require a compressor to provide the required compressed air. Manual, hand operated, rivet nut setting tools are known which enable a user freedom of movement but the force achievable for setting rivet nuts is limited to user strength.

### SUMMARY

According to the invention there is provided a portable electric rivet nut setting tool according to claim 1, wherein optional features thereof are defined in claims 2 to 16.

### BRIEF DESCRIPTION OF THE DRAWINGS

Various aspects and embodiments of the invention will now be described by way of non-limiting example with reference to the accompanying drawings, in which:

FIG. 1 illustrates a side-view of a portable electric rivet nut setting tool;

FIG. 2 illustrates a cross-sectional view of the tool in FIG. 1;

FIG. 2A illustrates a cross-sectional view of the tool in FIG. 2 along the axis A-A;

FIG. 3 illustrates the tool in FIG. 1 with part of the tool housing removed;

FIG. 4 illustrates the tool in FIG. 3 with a rivet nut mounted on the tool;

FIGS. 5 and 6 illustrate the tool in FIG. 4 positioned next to a hole in an object;

FIG. 7 illustrates the tool in FIG. 5 with a rivet nut extending through a hole in an object;

FIG. 8 illustrates a cross-sectional view of the tool in FIG. 7;

FIG. 9 illustrates the tool in FIG. 7 after a rivet setting operation;

FIG. 10 illustrates a cross-sectional view of the tool in FIG. 9; and

FIGS. 11 and 12 illustrate the tool in FIG. 9 following a reset operation.

### DETAILED DESCRIPTION

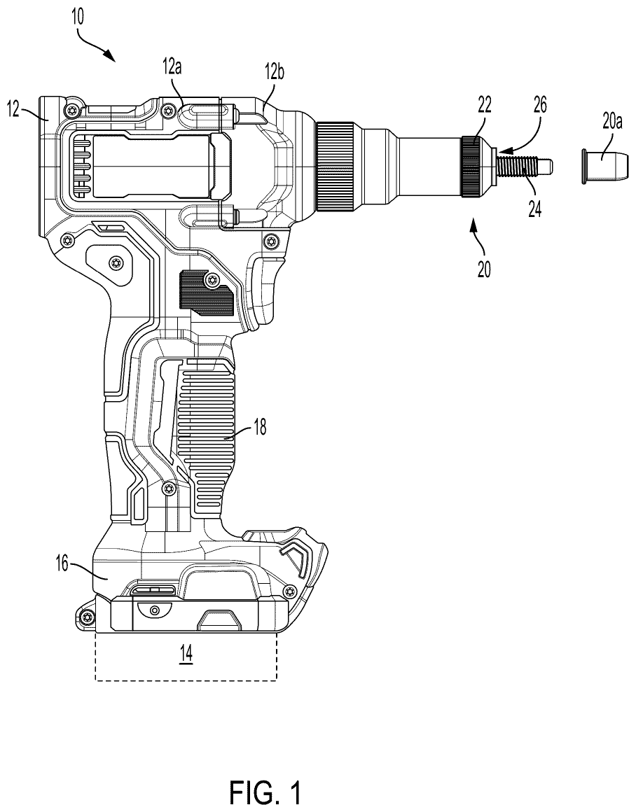

FIG. 1 shows a side view of a portable electric rivet nut setting tool 10. The tool 10 has a housing 12 part of which is formed of a plastic clam shell type construction 12a having two halves which are fastened together, another part of the tool housing 12 is a metal part 12b. A battery 14 is releasably connected to the base 16 of the handle 18 via a battery attachment feature. The tool 10 has a rivet nut setting mechanism 20 for setting a rivet nut. An anvil 22 of the rivet nut setting mechanism 20 is fixed relative to the tool housing 12 and defines an opening and an annular support surface 26 which faces away from the portable electric rivet nut setting tool 10 (to the right in FIG. 1). A threaded rod portion 24 of the rivet nut setting mechanism 20 extends through the opening defined by the anvil 22 and is moveable relative to the tool housing 12 and thus the anvil 22.

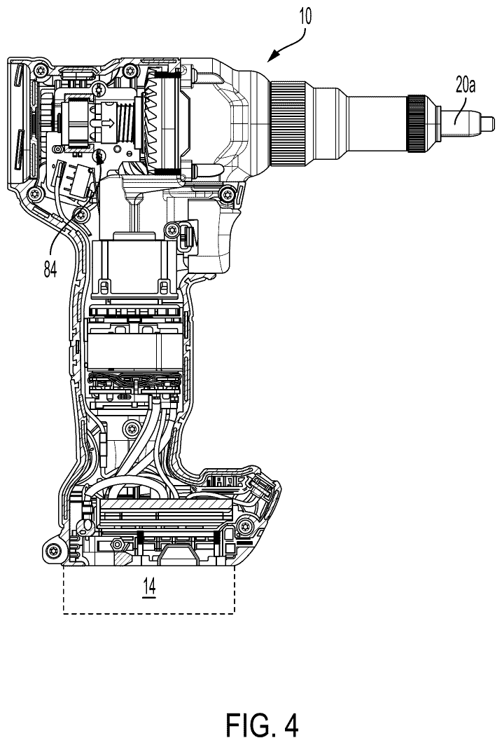

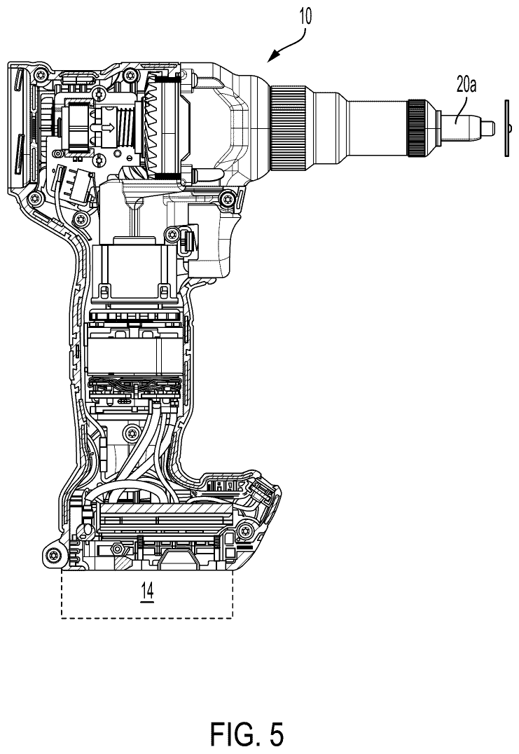

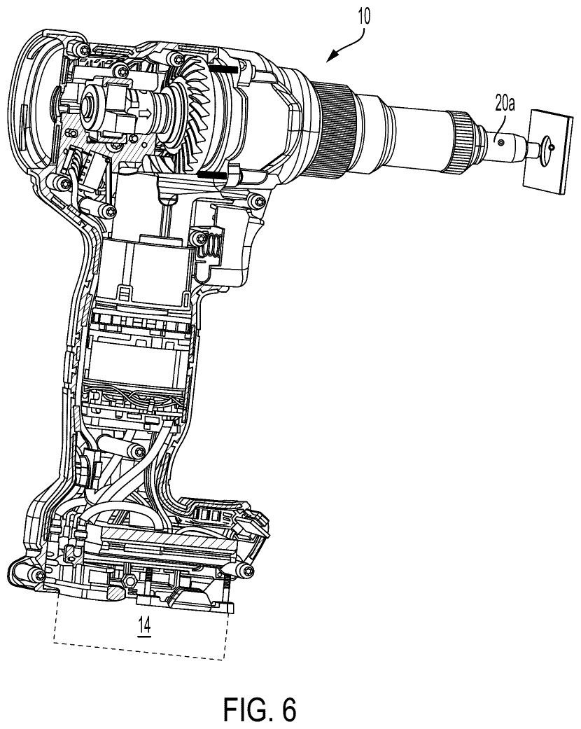

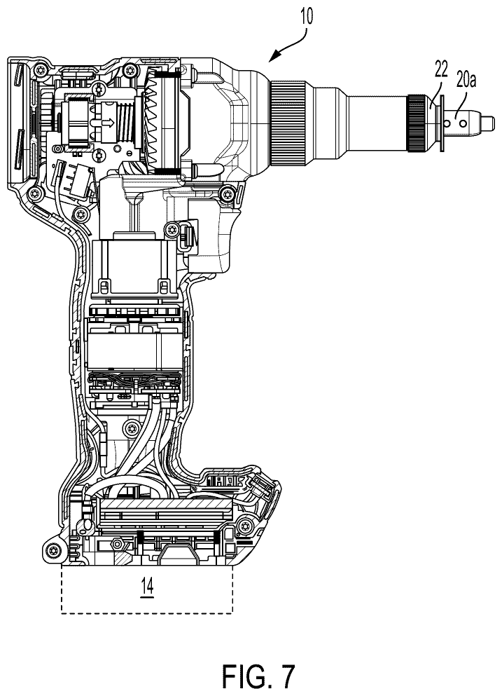

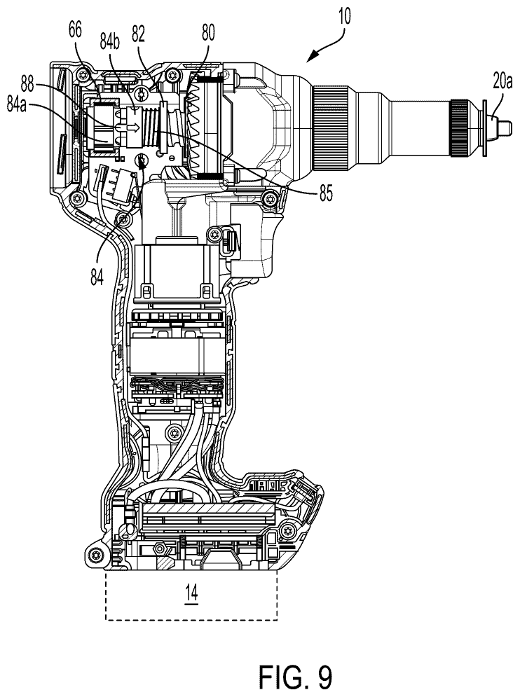

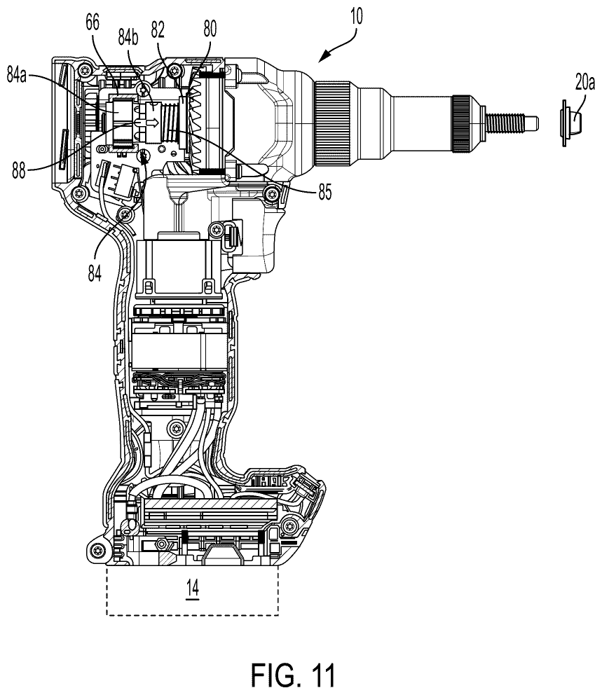

Basically, as will be familiar to persons skilled in the art, to set a rivet nut 20a the rivet nut (which has an internally threaded surface) is threaded onto the threaded rod portion 24 (see FIG. 4), the rivet nut 20a is then caused to extend through a hole in an object (see FIGS. 6 and 7), the threaded rod portion 24 is then moved such that the rivet nut 20a is urged against the annular support surface 26 of the anvil 22 for causing deformation of the rivet nut 20a (see FIG. 9). Ultimately a flange of the rivet nut 20a engages a first side of the object and the deformed/bulged part of the rivet nut 20a engages the other side of the object for retaining the rivet nut 20a in place. The threaded rod portion 24 of the rivet nut setting tool 10 is then unthreaded from the set rivet nut 20a (see FIG. 11) wherein the set rivet nut 20a provides a threaded attachment portion in the object to which objects can be threadably attached.

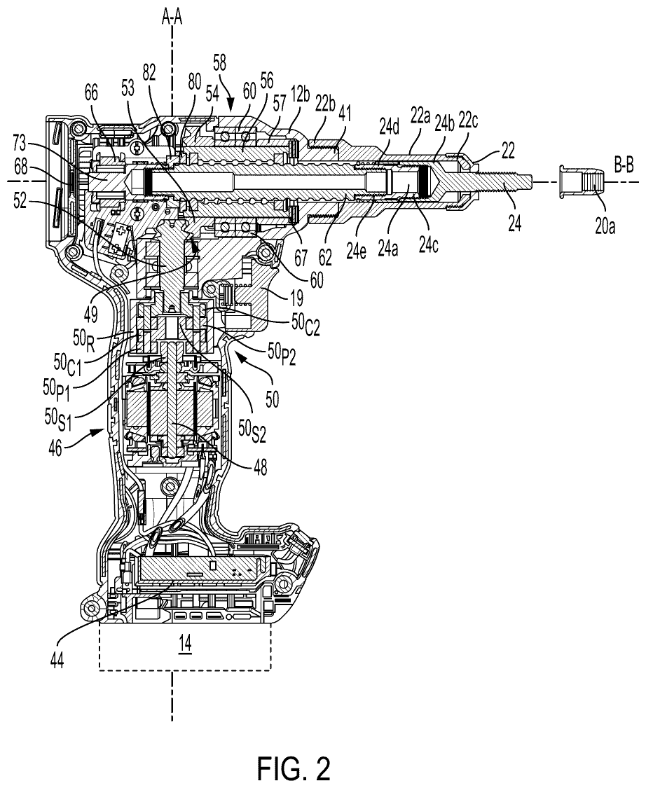

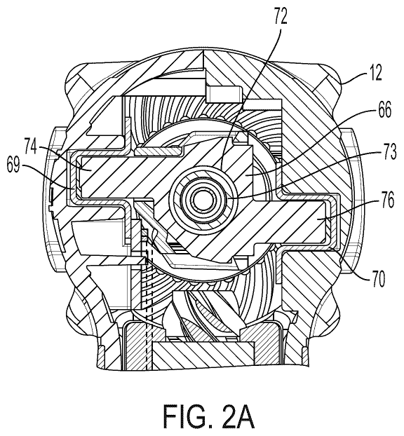

Internal features of the portable electric rivet nut setting tool 10 will now be described with reference to FIG. 2 which shows a side cross-sectional view of such power tool.

The power tool 10 has a controller 44 for determining that the trigger 19 has been pulled. In response to the controller 44 determining that the trigger 19 has been pulled the controller 44 generates a signal to activate an electric motor 46, which is a DC brushless motor. Persons skilled in the art will be able to select a suitable electric motor, however, an example of a suitable electric motor 46 is the BL41 DC brushless motor designed by Stanley Black & Decker Inc. and used in some commercially available DEWALT® branded power tools. The motor 46 is located in the handle 18 and has a motor output shaft 48.

Torque from the motor output shaft 48 is transferred via a transmission 50 to an input pinion 52 of a bevel gear arrangement 49. The transmission 50 comprises at least one planetary gear arrangement for reducing output speed while increasing torque. The motor output shaft 48 drives an input sun gear 50s1 of the first stage of the transmission 50. The input sun gear 50s1 meshes with a plurality of first stage planet gears 50p1 which mesh with a stationary outer ring gear 50R and are coupled to a first stage carrier 50c1. An axial extension of the first stage carrier 50c1 is the input sun gear 50s2 of the second stage of the transmission 50. The input sun gear 50s2 meshes with a plurality of second stage planet gears 50p2 which mesh with the stationary outer ring gear 50R and are coupled to a second stage carrier 50c2. An axial extension of the second stage carrier 50c2 is rotationally fixed to the input pinion 52 of the bevel gear arrangement.

The input pinion 52 of the bevel gear arrangement 49 thus rotates at a lower speed than the motor output shaft 48 however with an increased torque relative to the motor output shaft 48.

The motor output shaft 48, transmission 50 and input pinion 52 of the bevel gear arrangement 49 are aligned along a first axis A-A which extends along a longitudinal length of the handle 18. By also locating the battery attachment feature (and thus battery 14) on the first longitudinal axis A-A weight distribution of the portable electric rivet nut setting tool 10 is improved, whereby the power tool 10 feels balanced in a user's hand.

By locating the motor 46, the transmission 50 and the battery 14 on the same axis A-A extending along the length of the handle 18 improves weight distribution of internal features of the tool 10. Also by providing the motor 40 within the handle 18 leaves more space available within the tool housing 12 above the handle 18, whereby there is more freedom to position features of the tool 10 in positions which improve weight distribution of internal features of the tool 10.

It will be appreciated that there is some design freedom in the transmission 50 between the motor output shaft 48 and the input pinion 52 of the bevel gear arrangement 49. In particular the number of planetary gear stages, and its (or their) configuration, forming the transmission 50 depends on the required gear ratio to be achieved between the motor output shaft 48 and the input pinion 52.

Given that it is well known that planetary gear stages step down rotation speed while stepping up torque persons skilled in the art, based on the disclosure given herein, will be able to decide upon a suitable transmission arrangement which achieves the required gear ratio for thier tool to function; wherein the appropriate gear ratio depends on multiple factors including maximum achieveble motor output torque, pitch of the ball screw arrangement described below, friction between moveable features within the tool 10 and the maximum permissible pulling force (such as up to 20 kN). It will be appreciated that for some tools 10 a suitable transmisison 50 may only have a single planetary gear stage, whereas for other tools a suitable transmisison 50 may have a plurality of planetary gear stages arranged in series.

Continuing with reference to FIG. 2 a bevel gear 53 of the bevel gear arrangement 49, which is meshed with the input pinion 52 for receiving torque therefrom, is provided. An axial extension of the bevel gear 53, hereafter the driving sleeve 54, is rotationally fixed relative to an input sleeve 56 of a ball screw arrangement 58. The driving sleeve 54 and input sleeve 56 are fixed relative to each other due to a friction fit arrangement. An internal surface of the input sleeve 56 comprises a threaded surface. The outer surface of the input sleeve 56 is supported by bearings 60 which enable rotation of the input sleeve 56 with respect to the housing 12. In a radial direction the bearings 60 are located between the input sleeve 56 and the inner surface of the metal part 12b of the housing 12, whereas in an axial direction the bearings 60 are located between the driving sleeve 54 and a bearing engagement sleeve 57 which is rotatably fixed to the input sleeve 56 via a friction fit engagement; part of the bearing engagement sleeve 57 lips around the outer edge of an axial bearing 67 for preventing the axial bearing 67 from touching the inner side of the metal part 12b of the housing 12. A threaded rod 62 is mounted within the input sleeve 56, which extends through the input sleeve 56. A plurality of balls, such as metal ball bearings, ride in the opposing threaded surfaces of the input sleeve 56 and threaded rod 62, thereby defining a ball screw arrangement 58.

When the input sleeve 56 is rotatably driven by the driving sleeve 54 this causes axial movement of the threaded rod 62. In other words, torque from the electric motor 46 is transferred through the transmission 50, through the bevel gear arrangement 49 to the input sleeve 56, whereby rotation thereof causes axial movement of the threaded rod 62. The threaded rod 62 is configured to move along a second longitudinal axis B-B of the tool 10. The threaded rod 62 can move forwards or backwards along the axis B-B depending on the motor driving direction, whereby the threaded rod portion 24 of the rivet nut setting mechanism 20 moves with the threaded rod 62 because it is fixed relative to the threaded rod 62.

FIG. 2 illustrates that the threaded rod portion 24 of the rivet nut setting mechanism 20 is threaded onto the threaded rod 62 of the ball screw arrangement 58 via an intermediary connecter 24a. It will be appreciated however that other attachment means are suitable for fixing the threaded rod portion 24 of the rivet nut setting mechanism 20 relative to the threaded rod 62 of the ball screw arrangement 58 with or without an intermediary connector 24a.

FIG. 2A shows that an anti-rotation bar 66 is engaged with the threaded rod 62 in a manner whereby the anti-rotation bar 66 is axially and rotationally fixed to the threaded rod 62 in a first rotational direction. More specifically, as will be described in more detail later, a ratchet mechanism 72 is provided on the anti-rotation bar 66 which cooperates with a reciprocal threaded portion 73 at an end of the threaded rod 62 for blocking relative rotation between the anti-rotation bar 66 and threaded rod 62 of the ball screw mechanism 58 in a forwards rotational direction only; namely the rotational direction defined by the direction of rotation in which the input sleeve 56 is rotatably driven for causing a rivet nut setting operation. In other words during a rivet nut setting operation when the input sleeve 56 is rotatably driven in a forwards direction, and thus torque is applied to the threaded rod 62, the aforementioned rachet mechanism 72 blocks relative rotational movement between the anti-rotation bar 66 and the threaded rod 62 of the ball screw mechanism 58. The rachet mechanism 72 thus provides that as the input sleeve 56 is rotated during a rivet nut setting operation, and thus torque is applied to the threaded rod 62, instead of rotating the threaded rod 62 is caused to move linearly due to cooperation of the anti-rotation bar 66 with slots 69, 70 within the housing 12 which guide axial movement of the anti-rotation bar 66 and thus threaded rod 62 along the axis B-B. Moreover the anti-rotation bar 66 slides relative to the housing 12 through the slots 69, 70 during axial movement of the threaded rod 62.

The anti-rotation bar 66 comprises a first arm 74 and a second arm 76. The first and second arms 74, 76 are mounted in first and second slots 69, 70 within the housing 12. When the threaded rod 62 moves along the second longitudinal axis B-B, the first and second arms 74, 76 slide along the first and second slots 69, 70. The first and second slots 69, 70 extend along longitudinal axes which are parallel to the second longitudinal axis B-B.

With continued referenced to FIG. 2 the metal housing part 12b defines a lip 41 having an outer threaded surface which forms a threaded connection with an anvil support portion 22a. That is a proximal portion 22b of the anvil support portion 22a connects with the externally threaded lip 41 of the metal housing part 12b. A distal portion 22c of the anvil support portion 22a defines an externally threaded surface for threadably engaging an internally threaded anvil 22.

In the arrangement illustrated in FIG. 2 the threaded rod portion 24 of the rivet nut setting mechanism 20 has an expanded section 24b at its rear which defines an internally threaded surface. The intermediary connecter 24a has a first part 24c provided with an externally threaded surface for threadably engaging with the aforementioned expanded section 24b whereas the intermediary connecter 24a has a second part 24d having an internally threaded surface for threadably engaging with a threaded attachment portion 24e provided on the threaded rod 62 of the ball screw arrangement 58. This may seem complicated because in other embodiments the threaded rod portion 24 of the rivet nut setting mechanism 20 can be directly attached to the threaded rod 62 of the ball screw arrangement 58, however, it enhances flexibility of use.

For example imagine if the internally threaded portion within a rivet nut 20a to be set could not mate with the threaded rod 24 of the rivet nut setting mechanism 20 for example due to such features having different thread pitches or due to a difference in diameters. In such case a user can replace the threaded rod 24 of the rivet nut setting mechanism 20 with another configured to mate with the rivet nut 20a to be set, in particular by disconnecting the anvil support portion 22a from the metal housing part 12b, then replacing the threaded rod 24 of the rivet nut setting mechanism 20 with the other configured to mate with the rivet nut 20a to be set before reattaching the anvil support portion 22a to the metal housing part 12b. If the expanded section 24b of the replacement threaded rod 24 was configured to cooperate with the threaded attachment portion 24e provided on the threaded rod 62 of the ball screw arrangement 58 then the user would remove the intermediary connector 24a also and thread the replacement threaded rod 24 portion of the rivet nut setting mechanism 20 directly onto the threaded attachment portion 24e of the threaded rod 62; if however during such replacement process the user discovered that the expanded section 24b of the replacement threaded rod 24 was not suitable for threading onto the intermediary connector 24a or the threaded attachment portion 24e of the threaded rod 62 then they would need to replace the intermediary connector 24a with another configured to enable the replacement threaded rod 24 to be fixed relative to the threaded rod 62 of the ball screw arrangement 58. In all envisaged configurations the outer circumferential surface of the expanded section 24b of the threaded rod 24 of the rivet nut setting mechanism 20 slides along the inner surface of the anvil support portion 22a in use.

A volume 68 is provided within the housing 12 for accommodating the threaded rod 62 and the anti-rotation bar 66 when retracted into the tool 10 during a rivet nut setting operation in use. Designers are free to select a suitable way for the controller 44 to control operation of the motor 46 in use to implement a rivet nut setting operation. In other words designers are free to select a suitable way for the controller 44 to determine when a rivet nut 20a has been suitably set, namely designers are free to select a suitable way for the controller 44 to determine when the threaded rod portion 24 of the rivet nut setting mechanism 20 has been moved far enough linearly to have set a rivet nut 20a.

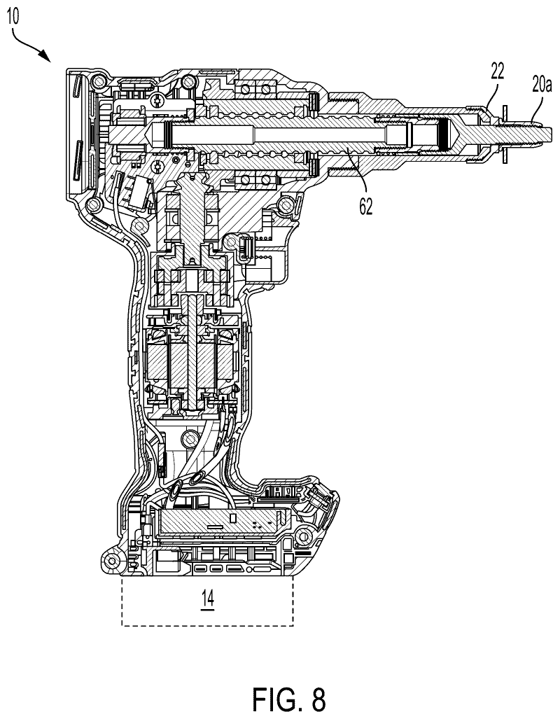

For example, in a starting configuration of the portable electric rivet nut setting tool 10 shown in FIGS. 7 and 8, a rivet nut 20a threaded onto the threaded rod portion 24 of the rivet nut setting mechanism 20 is about to be set. In this starting configuration the threaded rod 62 of the ball screw mechanism 58 is in a home position, which is a predetermined starting position along the second longitudinal axis B-B. Upon the controller 44 determining that the trigger 19 is pulled the controller 44 causes the electric motor 46 to rotate in a forward rotational direction for causing the threaded rod portion 24 of the rivet nut setting mechanism 20 to be linearly moved along the second longitudinal axis B-B for urging the rivet nut 20a against the anvil 22. In some embodiments users are required to manually judge when the rivet nut 20a has been set and thus are required to release the trigger 19 at the appropriate time, wherein upon the controller 44 detecting that the trigger 19 is released it implements a reset operation and causes the motor 46 to drive in a reverse direction for causing the threaded rod 62 of the ball screw mechanism 58 to return to its home position.

In other embodiments the controller 44 is configured to monitor motor current, that is real time current used by the electric motor 46 during a rivet nut setting operation. It will be appreciated that such motor current will increase during a rivet setting operation, particularly after a rivet nut 20a has been deformed sufficiently for functioning. Upon the controller 44 determining that motor current exceeds a threshold value, which is indicative that a rivet nut 20a has been set, the controller 44 implements a reset operation and causes the motor 46 to drive in a reverse direction for causing the threaded rod 62 of the ball screw mechanism 58 to be returned to its home position.

In other embodiments the controller 44 is configured to monitor motor speed, that is real time speed of rotation of the motor shaft 48 during a rivet nut setting operation. It will be appreciated that such motor speed will decrease during a rivet setting operation, particularly after a rivet nut 20a has been deformed sufficiently for functioning. Upon the controller 44 determining that motor speed reduces below a threshold value, which is indicative that a rivet nut 20a has been set, the controller 44 implements a reset operation and causes the motor 46 to drive in a reverse direction for causing the threaded rod 62 of the ball screw mechanism 58 to be returned to its home position.

In other embodiments the controller 44 is configured to pull back the threaded rod 62 of the ball screw mechanism 58 the same extent during each rivet nut setting operation implemented. To enable this, in such embodiments, a mechanical switch is provided within the power tool 10 for causing a reset operation upon the threaded rod 62 becoming retracted into the tool 10 by a predetermined amount. During a rivet nut setting operation the threaded rod 62 of the ball screw mechanism 58 is retracted into the tool 10 and eventually an arm 74, 76 of the anti-rotation bar 66 will engage a mechanical switch, whereby upon the controller 44 detecting that the mechanical switch is activated it implements a reset operation and causes the motor 46 to reverse direction and returns the threaded rod 62 to the home position; a user must then release the trigger 19 before a subsequent rivet nut setting operation can be implemented. In some embodiments instead of a mechanical switch an optical sensor can be used for detecting the presence of the anti-rotation bar 66 or threaded rod 62 for initiating a reset operation. Furthermore, in some embodiments a magnetic sensor is provided for detecting the presence of a magnet carried by the anti-rotation bar 66 for initiating a reset operation.

Alternatively in some embodiments the controller 44 is configured to receive user input via a user interface of the tool 10 which is indicative of one or more properties of the rivet nut 20a to be set, wherein based on this user input the controller 44 determines the extent to which the threaded rod 62 of the ball screw mechanism 58 should be retracted upon pulling the trigger 19. During a rivet nut setting operation, while the trigger 19 remains pulled the controller 44 will cause enough movement of the threaded rod 62 of the ball screw mechanism 58 for setting the indicated rivet nut 20a and then will implement a reset operation by reversing motor direction for returning the threaded rod 62 of the ball screw mechanism 58 to the home position, whereby the trigger 19 must be released before a subsequent rivet nut setting operation can be performed. At any time during a rivet nut setting operation if the trigger 19 is released the controller 44 will implement a reset operation and reverse movement of the motor 46 for returning the threaded rod 62 of the ball screw mechanism 58 to the home position.

Aspects of the portable electric rivet nut setting tool 10 particular to the reset operation will now be described in detail.

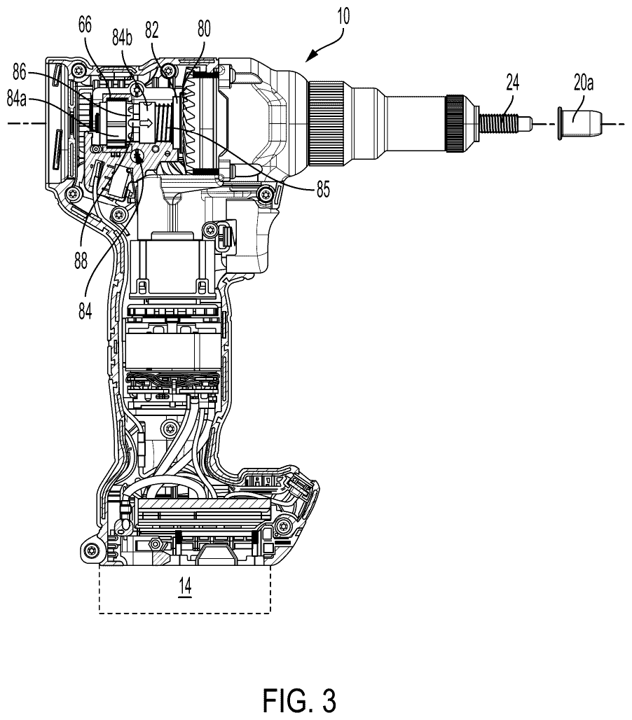

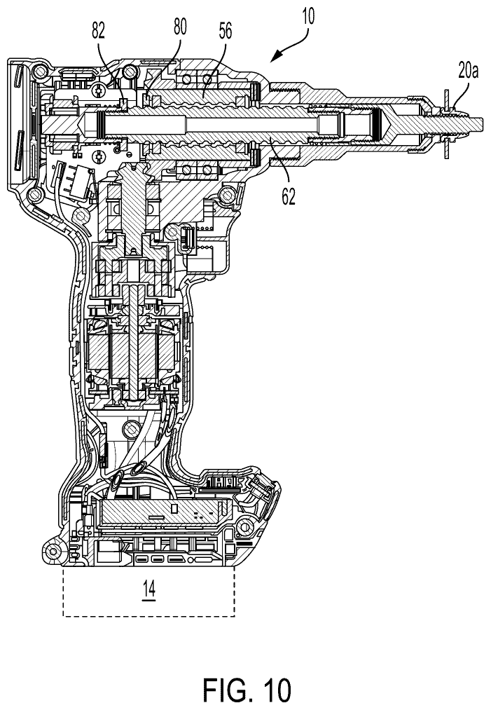

With reference to FIGS. 2, 3, 9 and 10 the input sleeve 56 of the ball screw mechanism 58 is provided with a first friction plate portion 80, which is fixed relative to the input sleeve 56. The threaded rod 62 of the ball screw mechanism 58 is provided with a second friction plate portion 82, which is fixed relative to the threaded rod 62. When the threaded rod 62 of the ball screw mechanism 58 is located in the heretofore described home position the first and second friction plate portions 80, 82 are in engagement with each other (like in FIGS. 2 and 3). During a rivet nut setting operation linear movement of the threaded rod 62 causes movement of the second friction plate portion 82 away from the first friction plate portion 80 (like in FIGS. 9 and 10). It will thus be appreciated that during a reset operation the first and second friction plate portions 80, 82 are brought back into engagement with each other.

Readers will recall the rachet mechanism 72 on the anti-rotation bar 66 which blocks relative rotational movement between the anti-rotation bar 66 and the threaded rod 62 of the ball screw mechanism 58 during a rivet setting operation. The rachet mechanism 72 does not block relative rotational movement between such features during a reset operation when the motor 46 is driven in reverse. During a reset operation the input sleeve 56 of the ball screw mechanism 58 is driven in a reverse direction, whereby a reverse torque is exerted on the threaded rod 62 which would freely rotate relative to the anti-rotation bar 66 were it not for the presence of a clutch mechanism 84. A first part 84a of the clutch mechanism 84 is provided on the anti-rotation bar 66 and is fixed relative to the anti-rotation bar 66, in the example illustrated said first part 84a is plurality of circumferentially distributed teeth 86 with ramped sides. A second part 84b of the clutch mechanism 84 is provided on the threaded rod 62 of the ball screw mechanism 58 and is rotationally fixed relative to said threaded rod 62 but can move axially relative to said threaded rod 62, in the example illustrated second part 84b defines a plurality of circumferentially distributed fingers 88. One or more projections on an inner side of said second part 84b are received in slots on said threaded rod 62 for rotationally locking said second part 84b relative to said threaded rod 62 but allowing axial movement. A spring 85 is located around the threaded rod 62 of the ball screw mechanism 58 between the second friction plate portion 82 and the second part 84b of the clutch mechanism 84 for urging the aforementioned circumferentially distributed fingers 88 against the circumferentially distributed teeth 86. During a reset operation of the portable electric rivet nut setting tool 10, when the input sleeve 56 of the ball screw mechanism 58 is driven in reverse and thus imparts a reverse torque on the threaded rod 62 of the ball screw mechanism 58 interlocking engagement between the first and second parts 84a, 84b of the clutch mechanism 84 prevents the threaded rod 62 of the ball screw mechanism 58 from rotating relative to the anti-rotation bar 66. During a reverse operation of the tool 10, as the input sleeve 56 is rotated in a reverse direction the anti-rotation bar 66 cooperates with the threaded rod 62 and slots 69, 70 within the housing 12 and the threaded rod 62 moves axially along the axis B-B, whereby the threaded rod 62 is moved towards its home position.

Eventually during such reverse movement of the threaded rod 62 towards its home position the first and second friction plate portions 80, 82 will engage each other again (like in FIG. 11), moreover when the threaded rod 62 arrives at the home position the first and second friction plate portions 80, 82 are forced against each other with sufficient force that reverse torque of the input sleeve 56 of the ball screw mechanism 58 can be transferred via the first friction plate portion 80 to the second friction plate portion 82 and thus to the threaded rod 62 of the ball screw mechanism 58, wherein continued reverse driving of the motor 46 after arrival of the threaded rod 62 at the home position causes (upon slip of the clutch mechanism 84 which is described in more detail below) rotation of the threaded rod 62, without further axial movement thereof, and thus rotation of the threaded rod portion 24 of the rivet nut setting mechanism 20 which can be used to easily remove the tool 10 from a set rivet nut 20a.

Designers are free to select a suitable way for the controller 44 to control operation of the motor 46 to implement a reset operation. In other words designers are free to select a suitable way for the controller 44 to determine when the threaded rod 62 of the ball screw mechanism 58 has returned to the home position at which point in time the first and second friction plate portions 80, 82 are engaged as mentioned above. For example a mechanical switch may be provided within the tool 10. Following a rivet nut setting operation, upon initiation of reverse movement of the motor 46 for causing a reset operation, the controller 44 is configured to detect output from the mechanical switch indicative that an arm 74, 76 of the anti-rotation bar 66 actuates the mechanical swich, thereby indicating that the threaded rod 62 of the ball screw mechanism 58 has returned to the home position. Alternatively an optical sensor may be provided within the tool 10 which generates output based on the presence or absence of the anti-rotation bar 66 or threaded rod 62 wherein based on output from the optical sensor the controller 44 can determine that the threaded rod 62 of the ball screw mechanism 58 has reached the home position. In some embodiments a magnetic sensor is provided for detecting the presence of a magnet carried by the anti-rotation bar 66 for generating output indicative that the threaded rod 62 of the ball screw mechanism 58 has reached the home position.

Regardless of how the controller 44 determines arrival of the threaded rod 62 of the ball screw mechanism 58 at the home position during a reset operation, in response to such determination the controller keeps rotating the motor 46 in the reverse direction and thus keeps rotatably driving the input sleeve 56 of the ball screw mechanism 58 in a reverse direction by a predetermined extent. The predetermined extent may be a predetermined amount of time such as 2 or 3 seconds. Alternatively in some embodiments the predetermined extent may be a predetermined number of motor turns wherein the controller 44 receives information indicative of motor turn information from the motor 46 which is a DC brushless motor whereby more specifically the controller 44 cooperates with control electronics of the brushless motor 46 in order to control the motor 46 and determine motor turn information; wherein the motor 46 embodies a plurality of Hall sensors and the control electronics thereof are able to generate the motor turn information based on output from the Hall sensors.

So in other words regardless of how the controller 44 determines arrival of the threaded rod 62 of the ball screw mechanism 58 at the home position during a reset operation, in response to such determination the controller 44 keeps rotating the motor 46 in the reverse direction and thus keeps rotatably driving the input sleeve 56 of the ball screw mechanism 58 in a reverse direction for a predetermined amount of time such as 2 or 3 seconds or until the controller 44 determines that a predetermined number or motor turns has occurred since determination by the controller 44 of arrival at the home position of the threaded rod 62.

During such continued reverse rotation of the motor 46 due to engagement of the first and second friction plate portions 80, 82 reverse torque is transferred to the threaded rod 62 of the ball screw mechanism 58, whereby the clutch mechanism 84 starts to slip. In other words the first and second parts 84a, 84b of the clutch mechanism 84 start to slip relative to each other. More specifically since the second part 84b of the clutch mechanism 84 is rotationally locked relative to the threaded rod 62 of the ball screw mechanism 58, the reverse torque applied to the threaded rod 62 drives rotation of the second part 84b of the clutch mechanism 84 causing the circumferentially distributed fingers 88 to ride up ramped sides of the circumferentially distributed teeth 86 thus causing axial movement of the second part 84b of the clutch mechanism 84 against bias of the spring 85. Continued reverse rotation of the threaded rod 62 of the ball screw mechanism 58 causes the first and second parts 84a, 84b of the clutch mechanism 84 to repeatedly interlock and then slip relative to each other in the manner described due to the circumferentially distributed fingers 88 repeatedly interlocking with the circumferentially distributed teeth 86 as the second part 84b of the clutch mechanism 84 is caused to rotate relative to the second part 84a of the clutch mechanism 84.

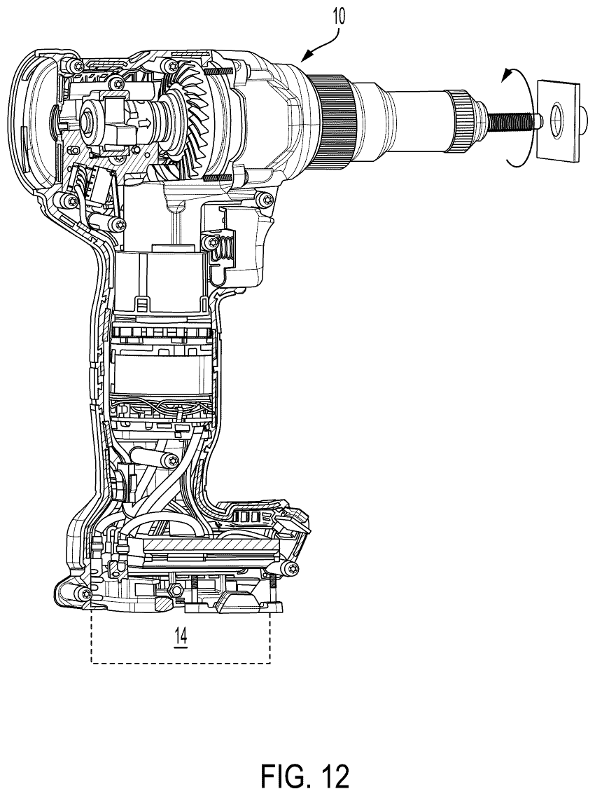

It will be appreciated that during such reverse driving stage when the clutch mechanism 84 is slipping that the threaded rod 62 of the ball screw mechanism 58 will rotate without moving axially whereby the threaded rod portion 24 of the rivet nut setting mechanism 20 will rotate without moving axially (see FIG. 12). As a result the rivet nut setting tool 10 can easily release itself from a set rivet nut 20a in a controlled way as an extension to the tool reset operation.

In some embodiments the predetermined extent to which the motor 46 is turned in a reverse direction following determination that the threaded rod 62 is at the home position during a reset operation is fixed but in others it is variable based on input received via a user interface of the tool 10. Such a user interface enables a user to inform the controller 44 of information indicative of one or more properties of the rivet nut 20a to be set, wherein based on this user input the controller 44 determines the extent to which the threaded rod 62, and thus threaded rod portion 24 of the rivet nut setting mechanism 20, should be rotated in order to release the tool 10 from the rivet nut.

It will be appreciated that whilst various aspects and embodiments have heretofore been described the scope of the present invention is not limited thereto and instead extends to encompass all arrangements, and modifications and alterations thereto, which fall within the spirit and scope of the appended claims.

In some embodiments the angle between the first longitudinal axis A-A and the second longitudinal axis B-B may not be 90 degrees which is achievable by adjusting the angle at which the input pinion 52 and the bevel gear 53 of the bevel gear arrangement 49 mesh. In some embodiments the angle between the first longitudinal axis A-A and the second longitudinal axis B-B may range between 45 degrees to 145 degrees. In some embodiments the portable electric power tool 10 can be an inline tool whereby the handle 18 is configured such that the motor shaft 48 and a major axis of the handle 18 are parallel with, in some embodiments coaxial with, the second axis B-B; such a tool may be referred to as being bar-shaped as opposed to being a pistol-grip tool.

In some embodiments the motor 46 is only partially received within the handle 18.

In some embodiments at least one planetary gear stage of the transmission 50 is received in the handle 18.

In some embodiments the motor 46 and the transmission 50 are received in the handle 18.

It has already been mentioned that by providing the motor 40 within the handle 18 leaves more space available within the tool housing 12 above the handle 18, whereby there is more freedom to position features of the tool 10 in positions which improve weight distribution of internal features of the tool 10. By providing the motor 46 only partially within the handle 18 achieves such advantage to a lesser extent. By providing the motor 46 and also at least part of the transmission 50 within the handle 18 achieves such advantage to a greater extent. By providing the motor 46 and also the transmission 50 within the handle 18 achieves such advantage to a fuller extent.

In some embodiments the battery 14 is removable from the tool 10 whereas in other embodiments the battery 14 is integral to the tool 10. Alternatively or additionally the tool 10 may be configured to receive electric power from a mains power supply.

As shown in FIG. 2 the driving sleeve 54 and input sleeve 56 are fixed to each other due to a friction fit arrangement. Alternatively the driving sleeve 54 and input sleeve 56 can be fixed via an interlocking arrangement such as a spline fit arrangement or other male and female interlocking-type arrangement.

The electric motor 46 has been described as being a brushless motor and the controller 44 cooperates with the brushless motor (in particular with its control electronics) in order to control the brushless motor. In other embodiments however the motor 46 may be a brushed motor having a motor output shaft driven by a stator and having at least one magnet on the motor output shaft; wherein such embodiments have one or more Hall sensors for detecting the at least one magnet on the motor output shaft and in response generating motor turn information which is received by the controller for use in counting motor turns. It is here mentioned that in battery operated embodiments the motor 46 is configured to operate using DC current, whereas in mains operated embodiments the motor is configured to operate using AC current.

In some embodiments the tool 10 may have a roller screw mechanism (sometimes known as a planetary roller screw mechanism) instead of a ball screw mechanism 58 for converting torque into linear force. A person skilled in the art will appreciate that this can be achieved by rotationally fixing the driving sleeve 54 to an input sleeve of the roller screw mechanism; wherein a set of rollers (sometimes called planetary rollers) are provided between the internal surface of the input sleeve and an external surface of the threaded rod 62. When the driving sleeve 54 is caused to rotate it drives rotation of the input sleeve of the roller screw mechanism and thus via the rollers causes linear movement of the threaded rod 62 and thus causes actuation of the rivet nut setting mechanism 20 via movement of the threaded rod portion 24.

In some embodiments the first and second friction plate portions 80, 82 may instead be first and second meshing portions configured to mesh with each other and transfer torque upon meshing with each other. For example a first friction plate portion 80 can instead be a first torque transferring member having a set of meshing features (e.g. a first set of circumferentially distributed teeth) and a second friction plate portion 82 can instead be a second torque transferring member having a set of meshing features (e.g. a second set of circumferentially distributed teeth) wherein upon engaging the first and second torque transferring members by interlocking the first and second set of meshing features torque can be transferred between the first and second torque transferring members; in such embodiments upon arrival at the home position of the threaded rod 62 of the ball screw mechanism 58 such aforementioned first and second torque transferring members mesh with each other for transferring torque.

What is claimed:

1. A portable electric rivet nut setting tool comprising an electric motor having a motor output shaft, a rivet nut setting mechanism having a threaded rod portion for mating with a rivet nut to be set and an anvil against which the rivet nut can be urged in use, the rivet nut setting mechanism being operatively coupled to the motor output shaft via a transmission of the tool which in use causes linear relative movement between the threaded rod portion and the anvil for setting a rivet nut in use, the transmission comprising a conversion mechanism for converting torque into a linear force for causing said linear relative movement between the threaded rod portion and the anvil of the rivet nut setting mechanism.

2. The portable electric rivet nut setting tool of claim 1 wherein the threaded rod portion of the rivet nut setting mechanism can be rotatably driven for releasing it from a set rivet nut.

3. The portable electric rivet nut setting tool of claim 2 wherein the conversion mechanism of the transmission comprises a first part that is axially fixed but rotatably drivable and a second part that is axially moveable between a home position and a retracted position upon rotation of the first part of the conversion mechanism in a forwards direction, the second part of the conversion mechanism being axially moveable back to the home position upon rotation of the first part of the conversion mechanism in a reverse direction, the tool being further configured such that continued reverse rotation of the first part of the conversion mechanism after the second part of the conversion mechanism has returned to the home position causes rotation of the second part of the conversion mechanism, the threaded rod portion of the rivet nut setting mechanism fixed relative to the second part of the conversion mechanism.

4. The portable electric rivet nut setting tool of claim 3 wherein the tool is configured such that the second part of the conversion mechanism is blocked from rotating in the forwards direction during rotation of the first part of the conversion mechanism in a forwards direction.

5. The portable electric rivet nut setting tool of claim 3 having a rachet mechanism for blocking rotational movement of the second part of the conversion mechanism in the forwards direction while allowing rotational movement of the second part of the conversion mechanism in the reverse direction.

6. The portable electric rivet nut setting tool of claim 3 wherein the tool is configured such that the second part of the conversion mechanism is blocked from rotating in the reverse direction during rotation of the first part of the conversion mechanism in the reverse direction for causing axial movement of the second part of the conversion mechanism back to the home position in use and upon continued reverse rotation of the first part of the conversion mechanism after the second part of the conversion mechanism has returned to the home position the second part of the conversion mechanism rotates in the reverse direction also.

7. The portable electric rivet nut setting tool of claim 6 having a first torque transfer mechanism which blocks rotation of the second part of the conversion mechanism during rotation of the first part of the conversion mechanism in the reverse direction for causing axial movement of the second part of the conversion mechanism back to the home position in use, a second torque transfer mechanism which is engaged upon arrival of the second part of the conversion mechanism at the home position in use for transmitting torque from the first part of the conversion mechanism to the second part of the conversion mechanism, wherein the tool is configured such that upon continued reverse rotation of the first part of the conversion mechanism after the second part of the conversion mechanism has returned to the home position and the second torque transfer mechanism is engaged the second part of the conversion mechanism rotates in the reverse direction due to slippage of the first torque transfer mechanism.

8. The portable electric rivet nut setting tool of claim 7 wherein the first torque transfer mechanism is a clutch mechanism having two parts urged together by a biasing member wherein one such part is rotationally locked relative to the second part of the conversion mechanism, optionally wherein the biasing member is a spring.

9. The portable electric rivet nut setting tool of claim 8 wherein said part rotationally locked relative to the second part of the conversion mechanism is axially moveable relative to the second part of the conversion mechanism.

10. The portable electric rivet nut setting tool of claim 7 wherein the second torque transfer mechanism has a first part rotationally locked relative to the first part of the conversion mechanism, the second torque transfer mechanism also having a second part rotationally locked relative to the second part of the conversion mechanism, wherein the first and second parts of the torque transfer mechanism are brought into engagement with each other when the second part of the conversion mechanism returns to the home position in use.

11. The portable electric rivet nut setting tool of claim 10 wherein the first and second parts of the second torque transfer mechanism are friction plate portions or the first and second parts of the second torque transfer mechanism each have meshing features configured to mesh and enable torque transfer between said first and second parts.

12. The portable electric rivet nut setting tool of claim 3 wherein the conversion mechanism is a ball screw mechanism, the first part of the conversion mechanism being an input sleeve of the ball screw mechanism, the second part of the conversion mechanism being a threaded rod of the ball screw mechanism.

13. The portable electric rivet nut setting tool of claim 3 wherein the conversion mechanism is a roller screw mechanism, the first part of the conversion mechanism being an input sleeve of the roller screw mechanism, the second part of the conversion mechanism being a threaded rod of the roller screw mechanism.

14. The portable electric rivet nut setting tool of claim 1 wherein: the electric motor is arranged at least partially within the handle of the portable electric rivet nut setting tool such that the motor output shaft extends along a first axis extending along the length of the handle; the portable electric rivet nut setting tool configured such that said relative movement between the threaded rod portion and the anvil of the rivet nut setting mechanism occurs linearly along a second axis; and the transmission comprises a bevel gear arrangement for redirecting torque flowing along the first axis and input to the bevel gear arrangement in use so that torque output from the bevel gear arrangement flows along the second axis and into the conversion mechanism.

15. The portable electric rivet nut setting tool of claim 14 wherein the angle between the first axis and the second axis is between 45 degrees to 145 degress, optionally 90 degress.

16. The portable electric rivet nut setting tool of claim 14 further comprising a battery attachment portion on the handle so that a notional line extending between the battery attachment portion and the motor output shaft extends along the first axis.
